(19) United States
(12) Patent Application Publication
(10) Pub. No.: US 2007/0038946 A1
(43) Pub. Date: Feb. 15, 2007

(54) Systems, methods and devices for controlling a multifunctional product using a scriptable user interface

(76) Inventors: Charles E. Grieshaber, Versailles, KY (US); Stephen F. Hunt, Lexington, KY (US); Benjamin S. Moore, Mt. Sterling, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/203,791

(22) Filed: Aug. 15, 2005

(51) Int. Cl. G06F 3/12

(52) U.S. Cl. 715/762; 358/1.1

(57) ABSTRACT

Methods for improved on screen creation for the Graphical User Interface (GUI) of an MFP (Multi-Function Product) by providing Java Virtual Machine (JVM) applications control of MFP built-in functions such as copy, scan, fax, e-mail and FTP. Flexible means of controlling the flow of application-user interaction are enabled to provide highly customizable sets of one or more MFP functions known as workflows, as well as scripting the GUI of an MFP to provide highly customized GUI screens that are presented to an MFP user to invoke such workflows. GUI screens that may be assembled through the use of VLML described screen components located in Java application programs processed through a JVM module and converted and rendered by the back end of the GUI.

### FIELD OF THE INVENTION

The present invention relates generally to multi-function products, and more particularly, to systems and methods that permit the customizing of a multi-function product's graphical user interface through the use of a Java virtual machine.

### BACKGROUND OF THE INVENTION

Multi-function products (MFPs), also known as multi-function devices, are designed to perform a variety of functions, including copying, faxing, scanning, printing, and emailing documents. MFPs are also typically connected to a business entity's computer network and document server to send data and/or command instructions to the MFP through the computer network.

An MFP typically includes a graphical user interface (GUI) that displays prompts containing graphic, icons, and text, to a user. The GUI permits a user to change a multitude of device settings, including, for example, paper size, paper source, darkness, orientation, number of copies, and other settings. These devices also include additional options related to the transmission of digital versions of a document, such as a fax number, output format, email address destination, and the like. Many of these optional settings are default settings that also may be changed by a user.

Unfortunately, however, current multi-function devices only permit customizable execution of functions (also known as “workflows”) implemented with static profiles and external server software, using predefined prompts. These predefined prompts allow for a single user input value of a specified type: string, integer, single selection, multiple selection, password, Boolean, or message. However, such use of predefined screens and external server software inherently limits the customization, configuration and versatility of creating customized workflows and generating customized user interface screens for an MFP.

Therefore, what is needed are multi-function devices or products that automatically control the flow of application interaction and allow for the automatic customization of screens rendered on the device's Graphical User Interface (GUI) for controlling built-in functions (e.g., Copy, Scan, Fax, E-mail and FTP).

### BRIEF SUMMARY OF THE INVENTION

According to an embodiment of the present invention, there is disclosed a method for controlling a Multi-Function Product (MFP) using a Graphical User Interface (GUI). The method includes receiving, at a GUI, a plurality of screen components defined by a markup language, and receiving, from the GUI, a request for a plurality of MFP functions, where the request is transmitted to a virtual machine. The method also includes controlling at least one of the MFP functions in response to the request.

According to one aspect of the present invention, the method includes displaying a plurality of screen components in response to the request. The method may also include receiving, from the GUI, a second request for changing a plurality of parameters associated with at least one of the plurality of MFP functions, where the second request is transmitted to a virtual machine. According to another aspect of the present invention, the request is associated with a user profile. According to yet another aspect of the present invention, the MFP functions are associated with at least one workflow. Additionally, the virtual machine may be a Java virtual machine, and the markup language may be a View Layout Markup Language.

According to another embodiment of the present invention, there is disclosed a method for rendering one or more screen components on a GUI of an MFP. The method includes receiving, from a scriptable GUI, a request to display a screen component, where the request is transmitted to a virtual machine. The method also includes retrieving a plurality of screen components defined by a markup language, assembling the plurality of screen components, and rendering the at least one of the screen components on the GUI in response to the request.

According to one aspect of the present invention, the plurality of screen components make up a whole screen. According to another aspect of the present invention, the method includes associating at least one attribute to at least one of the plurality of screen components. According to yet another aspect of the present invention, the at least one attribute may be an application identifier associated with at least one application. The at least one application may also be associated with at least one workflow. Additionally, the virtual machine may be a Java virtual machine, and the markup language may be a View Layout Markup Language.

According to yet another embodiment of the present invention, there is disclosed a system for controlling an MFP, including at least one application stored in a memory, where the application is associated with at least one workflow, and a virtual machine connected to the memory, where the virtual machine processes the at least one application and controls the operation of the at least one workflow based in part on the processing of the at least one application.

According to one aspect of the present invention, the system includes a back end of a GUI connected to the virtual machine, where the back end of the GUI suspends the control of the workflow by the virtual machine upon the detection of an error. According to another aspect of the present invention, the virtual machine is operative to send a plurality of screen components defined by a markup language to the back end of a GUI to be rendered on the GUI.

According to another embodiment of the present invention, there is disclosed an MFP. The MFP includes at least one application stored in a memory, where the application is associated with at least one of a plurality of screen components defined by a markup language and a back end of a GUI, where the back end of the GUI is operable to receive at least one of the plurality of screen components defined by a markup language. The MFP also includes a virtual machine, connected to the back end of the GUI, where the virtual machine sends a plurality of screen components to the back-end of the GUI based in part on the processing of the at least one application stored in memory.

According to one aspect of the present invention, the at least one application is associated with at least one workflow. According to another aspect of the present invention, the memory is remote to the MFP.

### BRIEF DESCRIPTION OF THE SEVERAL VIEWS OF THE DRAWING(S)

Having thus described the present invention in general terms, reference will now be made to the accompanying drawings, which are not necessarily drawn to scale, and wherein:

FIG. 1 is a block diagram of a Multi-Function Product (MFP), according to an embodiment of the present invention.

FIG. 2 is a flowchart of a workflow execution using the applications run on the Java Virtual Machine, in accordance with an exemplary embodiment of the present invention.

FIG. 3 is a flowchart of a process of rendering screens components on the GUI, in accordance with an exemplary embodiment of the present invention.

FIG. 4 shows a home screen GUI, according to an illustrative embodiment of the present invention.

### DETAILED DESCRIPTION OF THE INVENTION

The present invention is directed to systems, methods and devices for automatic customization of a user experience as it relates to workflow on an embedded device, such as an MFP. Specifically, the present invention described herein improves on screen creation for the GUI (Graphical User Interface) of an MFP (Multi-function Product) by giving Java Virtual Machine (JVM) applications control of the MFP built-in functions (Copy, Scan, Fax, E-mail and FTP). The present invention also allows for a flexible means of controlling the flow of application-user interaction to provide highly customizable sets of one or more MFP functions or workflows, as well as scripting the GUI of an MFP to provide highly customized GUI screens that are presented to an MFP user to invoke such workflows. The present invention provides GUI screens that may be assembled through the use of View Layout Markup Language (VLML) described screen components located in Java application programs processed through a JVM module and converted and rendered by the back end of the GUI.

The present invention is described below with reference to figures and flowchart illustrations of systems, methods, apparatuses and computer program products according to an embodiment of the present invention. It will be understood that each block of the flowchart illustrations, and combinations of blocks in the flowchart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware, firmware, and/or computer instructions. Embodiments of the present invention may be implemented through an application program running on an operating system of a computer. Embodiments of the present invention also may be practiced with other computer system configurations, including hand-held devices, multiprocessor systems, microprocessor based or programmable consumer electronics, mini-computers, mainframe computers, etc.

Application programs that are components of the present invention may include routines, programs, components, data structures, etc. that implement certain abstract data types, perform certain tasks, actions, or tasks. In a distributed computing environment, the application program (in whole or in part) may be located in local memory, or in other storage. In addition, or in the alternative, the application program (in whole or in part) may be located in remote memory or in storage to allow for the practice of the embodiments where tasks are performed by remote processing devices linked through a communications network.

The present invention will now be described more fully hereinafter with reference to the accompanying figures, in which like numerals indicate like elements throughout the several drawings. Some, but not all, embodiments of the present invention are described. Indeed, this present invention may be embodied in many different forms and should not be construed as limited to the embodiments set forth herein; rather, these embodiments are provided so that this disclosure will satisfy applicable legal requirements.

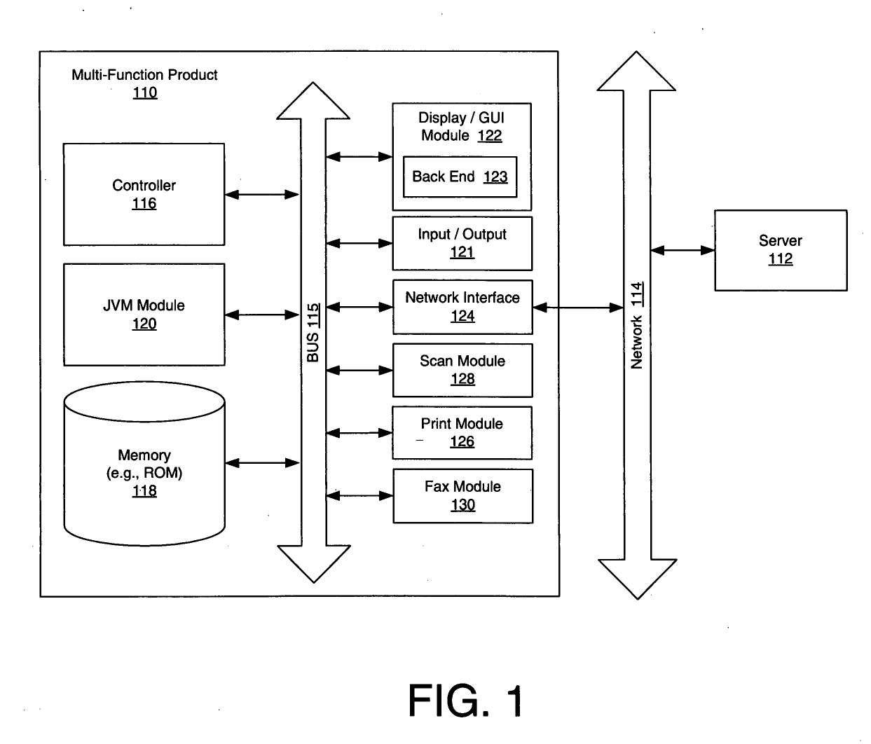

FIG. 1 shows a multi-function product (MFP) 110, according to an embodiment of the present invention. The MFP 110 may represent a multi-function device, such as a printer/scanner/fax/copier, or the control logic and/or control components within a multi-function device. The MFP 110 of an illustrative embodiment of the present invention generally includes a controller 116, Java Virtual Machine (JVM) module 120, memory 118, input/output 121, display/graphical user interface (GUI) module 122 with a back end 123, network interface 124, print module 126, scan module 128, and fax module 130, each of which may communicate with each other via a bus 115.

The print module 126, scan module 128, and fax module 130 may implement the printing, scanning and fax functions, respectively, of the MFP 110. According to an embodiment of the present invention, the print module 126 includes, for example, the necessary hardware, firmware, and/or software that allow the MFP 110 to print documents, including those submitted to the MFP 110 via a network 114 and the network interface 124, and those stored local to MFP 110. Similarly, the scan module 128 may include, for example, the necessary hardware, firmware, and/or software for scanning tangible documents on the MFP 110 and storing the scanned electronic documents in the memory 118, in a local attached memory device such as a flash drive, or in a remote memory on or in communication with the MFP 110 on the network 114. Likewise, the fax module 130 may include, for example, the necessary hardware, firmware, and/or software for faxing electronic documents over a telephone line (not illustrated) or the like. The fax module 130 may also have an internal scanning device for scanning tangible documents or may work with the scan module 128 for scanning tangible documents and faxing documents over a telephone line.

According to an embodiment of the present invention, the print module 126, scan module 128, and fax module 130 may operate in conjunction with the controller 116, which may handle at least a portion of the processing required to effect the printing, scanning and faxing functions of the MFP 110. For instance, according to an embodiment of the present invention, the scan module 128 may include a scan manager and the print module 126 may include a print engine, where the scan manager and print engine operate in conjunction with the controller 116 to handle printing and scanning processing, respectively, or the MFP 110. Similarly, the fax module 130 may include a fax engine and/or additional software, firmware, and/or hardware for implementing fax functions, as known in the art, or may also utilize processing implemented by the controller 116 to effect fax functions.

It should be appreciated that the components described herein with respect to FIG. 1 may include computer-executable software running in conjunction with computer hardware. For instance, as illustrated in FIG. 1, and as described in detail below, the print module 126, scan module 128, fax module 130, and display/GUI module 131 may include computer executable programs (i.e., software) stored within one or more memories of the MFP 110 that are executed by the controller 116 and/or JVM module 120 described below to effect the functions described in detail herein. It will also be appreciated that the print module 126, scan module 128, and fax module 130 can include any suitable electronic and mechanical elements that together effect printing, scanning, and faxing functions, respectively, of the type that conventionally occur in commercially available multifunction machines. Such elements are well-understood by persons skilled in the art to which the present invention relates. Therefore, details of the print module 126, scan module 128, and fax module 130, including the mechanical and other details of the manner in which they are constructed and communicate with one another and other elements to perform conventional printing, scanning, and faxing functions are not described in further detail herein.

The controller 116 may be a processor that executes computer executable programs with the aid of an operating system (not illustrated). According to other embodiments, one or more of the components illustrated in FIG. 1 may comprise hardware, such that the functions described herein are performed by hardware components. For instance, the controller 116, print module 126, scan module 128, fax module 130, and/or display/GUI module 122 may be implemented by an application-specific integrated circuit (ASIC), firmware, dedicated components, or the like, as are known in the art. Thus, it will be appreciated that the MFP 110 may be implemented in an entirely hardware embodiment, an embodiment combining software and hardware, or an embodiment combining hardware, firmware, and/or software. Additionally, one or more of the components illustrated in the MFP 110 of FIG. 1 may be combined to implement the methods and functions described in detail herein.

The MFP 110 is illustrated in FIG. 1 as being operatively coupled to (i.e., in communication with) the network 114, such as a LAN, WAN, wireless network, or the like, via the network interface 124. The connection of the MFP 110 to the network 114 enables the MFP 110 to communicate with remote computing devices, such as one or more computers. According to an embodiment of the present invention, the MFP 110 may communicate with a server 112 via the network 114. The server 112 may be, for instance, a document server that works in concert with the MFP 110 for performing special functions on electronic documents that may be handled by the MFP 110. For example, the MFP 110 may work in concert with the server 112 for emailing electronic documents scanned by the MFP 110 to a desired electronic address accessible via the network 114. As another illustrative example, the MFP 110 may receive print requests from the server 112. Thus, the network 114 may represent a LAN that is in communication with a WAN, such as the Internet. The server 112 may also include specialized functions for setting up and controlling the operations of the MFP 110. It should also be apparent to those of ordinary skill that it is within the scope of the present invention that the server 112 and MFP 110 may be combined into a single unit operatively coupled to the network 114.

The MFP 110 includes at least one memory 118 operable to store data created or received by the MFP via the network 114 and the network interface 124. The memory 118 may include ROM, RAM, optical media, or other storage, as are well known in the art. According to an embodiment of the present invention, the memory 118 is operable to store workflows and VLML specification data. VLML is a language derived from Extensible Markup Language (XML) that describes screen components for display on a GUI and is described in further detail below. According to one aspect of the present invention, the memory 118 may also store data, such as workflows and VLML specification data uploaded to the memory 118 from a portable memory device via a portable memory interface (not illustrated) of the input/output 121. The portable memory interface may permit the MFP 110 to read/write (R/W) from a disk drive, R/W CD drive, [R/W DVD drive?], flash media, USB device, or the like that is in communication with the MFP 110. For instance, the MFP 110 may receive a .PDF type document from a flash media inserted into the portable memory interface. According to one aspect of the present invention, such a portable memory R/W device may also be a read-only device, such as read-only CD drive.

As is also shown in FIG. 1, the MFP 110 includes a display/GUI module 122 that controls the display of information on a display or GUI, which may be an input/output device of the MFP 110. The display/GUI module 122 includes numerous features described in detail herein to enable users to access, store, and organize workflows. The manipulation of such workflows is enabled by GUI screens presented to the user via a display or GUI. Additionally, as is described in detail below, the display/GUI module 122 may operate in conjunction with the JVM module 120 to provide users with customized user interfaces as well as customized workflows.

According to an embodiment of the present invention, a display or GUI of the MFP 110 may include an icon-based touch-screen (or similar) interface. It will be appreciated by those of ordinary skill in the art that the display or GUI may include any type of moveable-cursor-based interface, which would typically necessitate the use of a cursor-control device such as a mouse, a roller ball, or any similar cursor-control devices known by those of ordinary skill. According to one aspect of the present invention, the GUI module 122 includes GUI software that operates in accordance with conventional windowing GUI paradigms.

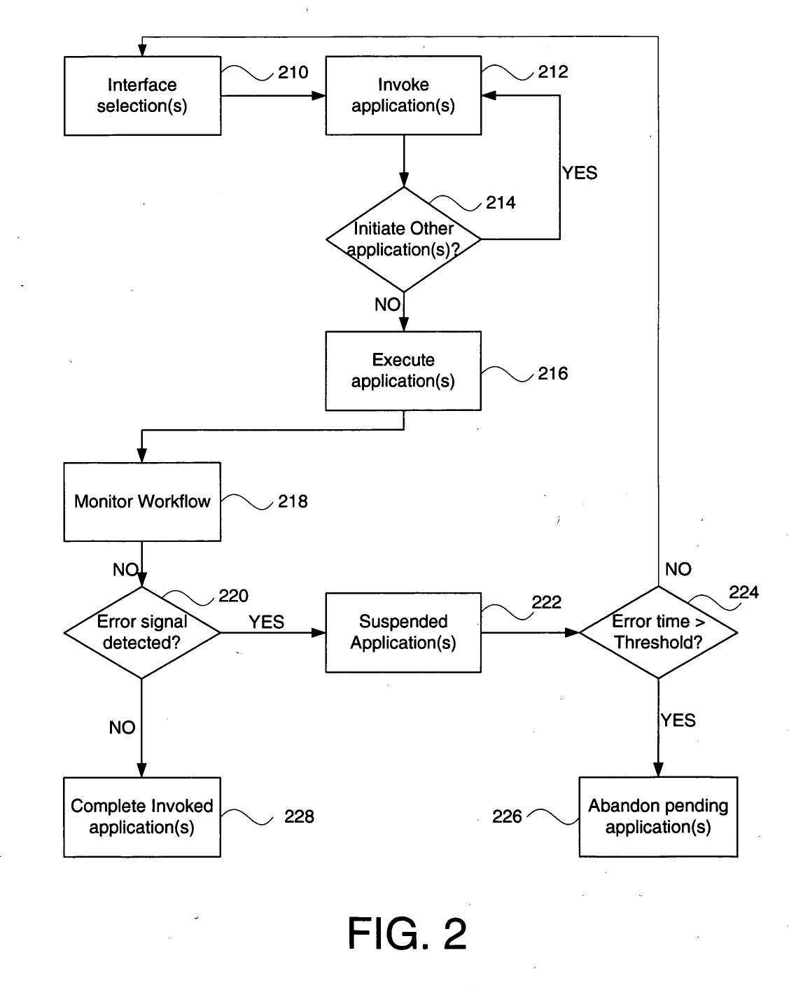

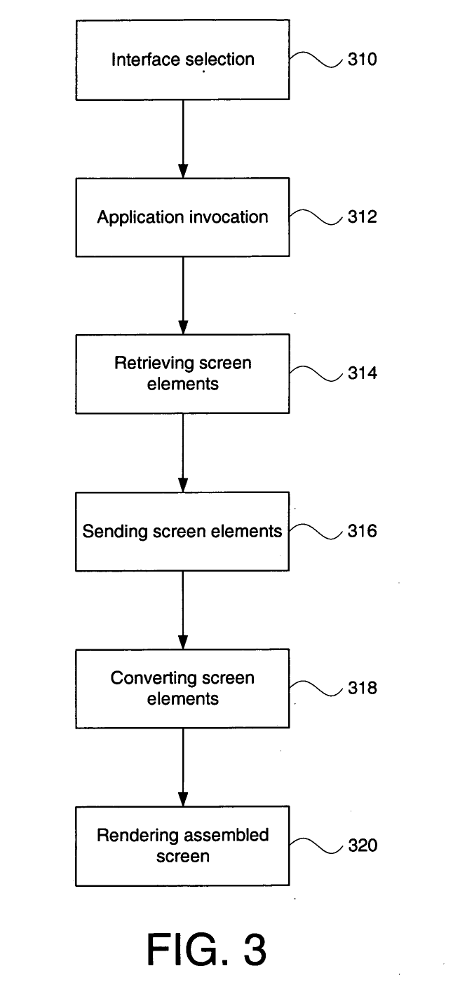

The native GUI back end 123 in the illustrative embodiment is part of the GUI module 122. This back-end 123, working in conjunction with the controller 116, is responsible for many functions. The back-end is responsible for arbitration of system resources, two-way communication with the Java-based services of the JVM module 120, invocation/management of the core workflows, and interpretation of VLML described screen components utilized by applications operating through the JVM module 120 into native components recognizable and capable of being rendered on the GUI with the GUI software. Further detail of the GUI back end 123 operation will be discussed below in reference to FIGS. 2 and 3.

The JVM module 120 is a Java virtual machine (JVM) operating on the MFP 110. The JVM module 120 includes software that acts as an interface between Java binary code and hardware of the MFP 110, such as the controller 116, which executes the JVM module's 120 instructions. Generally, it will be appreciated that once a JVM has been provided for the particular hardware platform for a device, any Java program can run on that platform. This allows application programs, or scripts, to be built that could be run on any platform without having to be rewritten or recompiled by a programmer for each separate platform.

For example, a screen described in a Java application, properly specified with the use of VLML recognizable elements, that is installed on two MFPs each operating on different hardware platforms could be rendered on their respective GUI screens through the JVM module 120 particular to that MFP's hardware platform. The use of JVMs allows for programming various MFPs running on different hardware platforms with one set of Java code. It also allows for a modular approach to creating Java application programs by automatically assembling new Java application programs by reorganizing and regrouping various Java script routines accessible to the MFP's JVM module 120. It will be appreciated to one of ordinary skill in the art that the present invention may also be implemented using virtual machines that are not Java based, rather utilizing other programming languages.

According to an embodiment of the present invention, the MFP 110 described with respect to FIG. 1 is operable to store and execute workflows and to customize various screen components to be rendered on a GUI. According to one aspect of the present invention, workflows can include print jobs, confidential jobs, scan jobs, fax destinations, and other functions that may be executed by the MFP 110. In addition to items for execution, workflows may also include user profiles, settings, VLML-described GUI screens, and data associated with functions of the MFP 110.

The memory 118 is operable to store applications, workflows, Java application code, VLML specification data and other data. The VLML is an XML language based on the GUI software being used in a particular MFP. VLML is not unlike other GUI scripting languages, such as extensible user-interface language (XUL), used in several web browsers. The VLML specification describes the set of fundamental components or markup language tags corresponding to physical screen component attributes, such as image, button, label, layout, and the like, as well as functional attributes for assembling a full screen to be rendered on the GUI through the back end 123. In other words, the VLML described or “tagged” screen components include VLML layout components and VLML widget components. VLML widget components describe visual components such as a buttons, text boxes, images and other visual screen components. VLML layout components describe non-visual screen components, which include the positioning of the widget component on the screen, functions which are associated with the selection of a particular widget component, etc. The VLML components including widgets, layouts and other VLML described components both physical and functional can be utilized in a hierarchical fashion, with several VLML components being associated with the same data as other VLML components, or VLML components being associated with other VLML components.

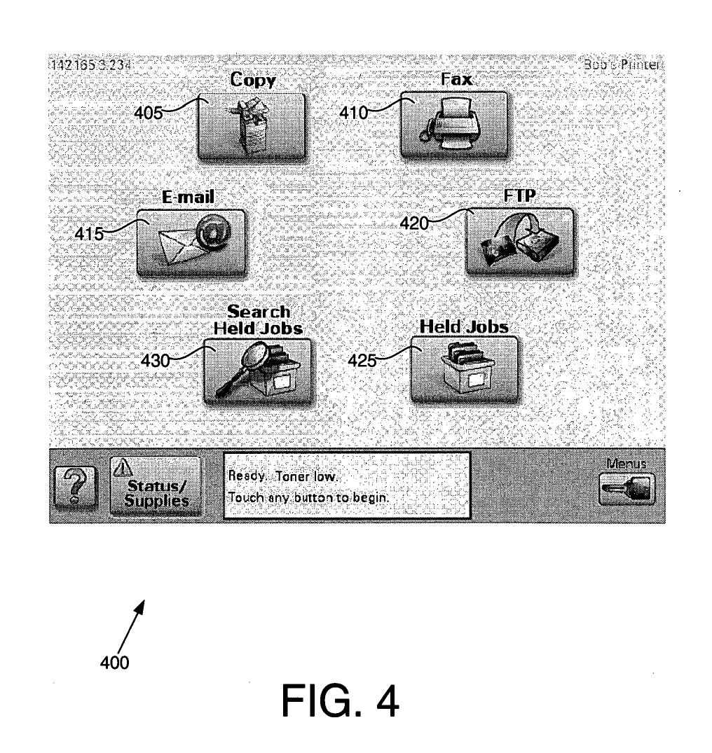

By combining multiple tags in a Java application program implemented on the JVM module 120, a VLML document is able to fully describe an entire screen's components, layout, and associated functional attributes. For example, VLML tags can specify a row of buttons where each button corresponds to initiating one or more Java application programs for implementing one or more workflows. Such workflows can be to initiate a series of MFP functions or retrieve a new GUI screen, etc. It will be appreciated by one of ordinary skill in the art that a markup language other than VLML may be employed to describe the screen components, formats, and attributes associated therewith for processing by the Java virtual machine module 120 and the back end 123 of the MFP GUI. An illustrative GUI for performing such functions are described in detail with respect to FIG. 4.

It will be appreciated that the MFP 110 illustrated in FIG. 1 is according to an illustrative embodiment of the present invention. Therefore, one or more of the MFP 110 components described herein may be combined and/or placed external to the MFP 110, including remote from the MFP 110. Additionally, although described herein as a multi-function module, one or more of the components may be optional or unnecessary. For instance, the MFP 110 may represent a device that does not include a fax function, so that the MFP 110 may not include a fax module. Furthermore, although described herein as a MFP 110, according to an embodiment of the present invention, the MFP 110 may alternatively have only a single or dedicated function, such as a scanning function requiring only the scan module 128. Other embodiments of the MFP 110 are possible. For instance, although the print module 126, scan module 128, fax module 130, and GUI module 122 are illustrated as independent components, each may be stored within one or more memories of the multi-function device 110, such as memory 118, and each may be stored in whole or part external to the MFP 110 and fetched into memory 118 on an as-needed basis. Other software elements of the types conventionally included in personal computers, such as an operating system and communications software, are also included but not shown for purposes of clarity.

FIG. 2 is a flowchart of a workflow execution implemented using one or more applications run on the JVM module 120, in accordance with an exemplary embodiment of the present invention. In addition to controlling the VLML-based screens, the process of which is described below in FIG. 3, the JVM module 120 provides access points for inspecting, configuring, modifying and invoking the workflows available on the MFP 110. The access points may contain default parameter values some or all of which may be selectively modified by the user.

In an exemplary embodiment of the present invention, there are five core functions on the MFP: Copy, Scan-to-Document, Fax, E-mail and FTP. These core functions can be combined in a variety of ways to create unique workflows implemented through Java applications utilized by the JVM module 120. Further customization of workflows are also available through the MFP GUI, where a user has the ability to configure many workflow parameters associated with each unique workflow. Workflow parameters configurable by JVM clients include input type (e.g., paper, electronic, format, file extension, etc.), image quality (e.g., color, brightness, resizing, cropping, etc.), and output options (e.g., fax numbers, destination email addresses, number of copies, user identification data, etc.). All of the core workflows, along with multiple methods for invoking them, are accessible to installed applications via the JVM module 120.

Once workflows are installed on the MFP 110, they are associated with a profile. Profiles are accessible from within the native GUI and may be invoked via icons on the home screen, the profile list, or with a customizable shortcut number, and can be associated with Java application programs. For profiles to support Java application programs, a new profile type is defined that contains a unique application identifier (AppID) as well as the system resources required by the profile.

When an application-based profile is invoked by the user in block 210, the GUI back-end determines what resources are to be used and whether an application must be invoked via its AppID. Next, block 212 is invoked where the appropriate system resources are monitored and an invocation request is sent to the JVM from the native code. Once this point is reached, the executing application may install VLML screens, as will be described in further detail below with reference to FIG. 3, or invoke complete or partial workflows. There is no limitation on the order of these invocations or what types of screens may be described by the VLML, so long as they correspond to the attributes included in the VLML specification.

An application may invoke the complete workflow, only the configuration stage, or only the scanning/processing portion of the workflow. Allowing an application to break a workflow into separate phases of execution gives it the opportunity to insert its own screens, via VLML, before or after any of the individual stages of workflow execution. This provides additional customizing options for existing MFP workflows, as well as creating entirely new workflows via Scan-to-Document. In anticipation of highly specialized and intricate user interactions, the Java-based services also allow for one application to invoke another. Thus, a customized solution may be constructed from many individual applications that are pieced together and invoked by one another. The initiation of additional applications or applications embedded in other applications is conducted by block 214, which allows block 212 to invoke each additional application necessary for the workflow(s) or screens generation required by the user selections on the GUI. Once an application is invoked its particular function is executed by block 216.

Applications use the back-end 123 of the GUI to customize the workflow user experience. While an application is executing, block 218 is invoked where the back-end 123 of the GUI monitors the resources required by the application, such as the scanner and printer engine. If an error occurs with the utilized resource, as detected by block 220, then block 222 is invoked, and the back end 123 is able to interrupt or suspend the executing application to use its built-in error resolution capabilities, which are commonly known in the art (e.g., generating associated error messages, running system checks, etc.). In block 224, if the error is not corrected after a certain period of time or an override occurs at the request of the MFP user, then block 226 may be invoked to abandon the pending applications. Once the error has been corrected, the user may restart the selected applications at blocks 210, or alternatively the process may start at 212 as long as the users selections were retrievable and/or saved in an accessible memory location.

Once the error has been corrected and no other error has been detected by the back-end 123, then block 228 is invoked and the application is resumed and execution continues. Through this mechanism, embedded applications need be minimally aware of specific products and may focus on more abstract devices, allowing for more flexibility and reuse of the application-based solutions.

FIG. 3 is a flowchart of a process of rendering screen components on the scriptable GUI, in accordance with an exemplary embodiment of the present invention. As each workflow on the MFP is unique, the screens for configuring each workflow are tailored to fit the adjustable parameters. The Copy, Fax, E-mail, and FTP workflows are available to the user from the native GUI while the Scan-to-Document workflow provides interface points for scanned data to be used by Java application programs installed on the MFP. The GUI will transparently use the modified configuration with its built-in screens. In some cases, the JVM-based workflows utilized by the Java application programs may forgo the built-in screens completely and provide its own, completely unique customization screens.

Since JVM applications provide a rich programming environment, their screen requirements cannot be known ahead of time. FIG. 3 describes the process utilized by the MFP for retrieving the appropriate screen components or uniquely configured screens written using VLML associated with the selected application and/or settings made by a user on the MFP GUI and for sending those VLML-based screen components or uniquely configured screens to the GUI from applications installed within the embedded JVM module 120. The process described in FIG. 3 of rendering a customized screen on the MFP GUI involves primarily the use of three major components: View Layout Markup Language (VLML), the JVM module 120 and its associated workflows and Java application programs stored in memory 118 or other memory location, and the back end 123 embedded within the MFP GUI.

The process of screen creation shown in FIG. 3 begins at block 310 with the MFP user making a selection of an item on the GUI such as a workflow or setting, etc. One or more of the selections are associated with a request to display one or more screen components, or an entire screen. Once one or more selections have been made by the user, block 312 is invoked which retrieves the applications associated with the particular user selection(s) through an associated AppID. The selected applications are then retrieved and utilized by the JVM module 120. This functionality allows Java code to have near full control of the screen, taking over for the embedded GUI.

As the JVM module 120 runs the workflows associated with a particular application, the script code contains VLML described or “tagged” screen components. Block 314 retrieves these VLML described screen components (widgets, layouts, etc.) stored in memory. Once the VLML described screen components associated with the applications selected by the user have been retrieved, block 316 is invoked and those screen components are sent to the back end 123 of the MFP GUI. Next block 318 is invoked to have the back end of the MFP GUI convert and/or assemble the VLML described screen components to the native language of the MFP GUI. Once the VLML screen components have been converted and/or assembled to the native software language used by the MFP GUI, block 320 is invoked to render the converted and/or assembled screen components on the GUI screen.

FIG. 4 is an exemplary GUI screen that may be assembled through the use of VLML described screen components located in Java application programs processed through the JVM module 120 and converted and rendered by the back end 123 of the MFP GUI. FIG. 4 shows a home screen GUI 400 that may be presented to users by the MFP 110, according to an embodiment of the present invention. The home screen GUI 400 includes icons allowing a user to activate several basic functions of the MFP 110. According to one aspect of the present invention, the icons may be selected by touch, where the display/GUI 122 is a touch screen display. Alternatively, the options may require the use of a cursor, one or more softkeys, or the like, as are known in the art. As shown in FIG. 4, these basic functions may include, for example, a faxing function represented by a fax icon 410, a copying function represented by a copy icon 405, a scan-to-email function represented by the email icon 415, and an FTP function represented by the FTP icon 420.

Upon selecting the fax icon 410, the GUI module 122 in conjunction with the JVM module 120 will then provide a screen that includes icons and associated fields for allowing the user to fax an electronic document stored by or scanned into the MFP 110 over the network 114. Upon activating the copy icon 405, the GUI may advance to a graphical interface providing icons and fields for controlling the copying functions of the MFP 110. Similarly, upon activating the email icon 415, the GUI may advance to an interface for allowing the user to type in an email message and attach electronic documents (either stored by the MFP 110, scanned by the MFP 110, stored on the server 112, or available over the network 114) to the email message and send that email over to an electronic address over the network 114.

As shown in FIG. 4, the home screen GUI 400 also includes a search held jobs icon 430 and a held jobs icon 425. According to the illustrative embodiment of FIG. 4, the held jobs icon 425 may be a list under which all workflows are accessible. Thus, the exemplary home screen GUI 400 permits a user to access workflows associated with the MFP 110. According to one aspect of the present invention, whenever the held jobs icon 425 includes any items, such as one or more workflows, the search held jobs icon 430 will also be presented on the home screen GUI 400. The selection of the search held jobs icon 430 may open up a search GUI screen. Various other screens in addition to the exemplary home screen of FIG. 4 may be created by the JVM module 120 and back end 123 to control and provide the settings for one or more applications, profiles, or workflows.

Many modifications and other embodiments of the present invention set forth herein will come to mind to one skilled in the art to which this invention pertains having the benefit of the teachings presented in the foregoing descriptions and the associated drawings. Therefore, it is to be understood that the present invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for controlling a Multi-Function Product (MFP) using a Graphical User Interface (GUI), comprising:
receiving, at a GUI, a plurality of screen components defined by a markup language;
receiving, from the GUI, a request for a plurality of MFP functions, wherein the request is transmitted to a virtual machine; and
controlling at least one of the plurality of MFP functions in response to the request.

2. The method of claim 1, further comprising displaying a plurality of screen components in response to the request for the plurality of MFP functions.

3. The method of claim 2, further comprising receiving, from the GUI, a second request for changing a plurality of parameters associated with at least one of the plurality of MFP functions, wherein the second request is transmitted to the virtual machine.

4. The method of claim 1, wherein the request is associated with a user profile.

5. The method of claim 1, wherein the MFP functions are associated with at least one workflow.

6. The method of claim 1, wherein the virtual machine is a Java virtual machine.

7. The method of claim 1, wherein the markup language is View Layout Markup Language.

8. A method for rendering one or more screen components on a Graphical User Interface (GUI) of a Multi-Function Product (MFP) comprising:
receiving, from a scriptable GUI, a request to display a screen component, wherein the request is transmitted to a virtual machine;
retrieving a plurality of screen components defined by a markup language;
assembling the plurality of screen components; and
rendering, in response to the request, at least one of the plurality of screen components on the GUI.

9. The method of claim 8, wherein the plurality of screen components make up a whole screen.

10. The method of claim 8, further comprising associating at least one attribute with at least one of the plurality of screen components.

11. The method of claim 10, wherein the at least one attribute is an application identifier associated with at least one application.

12. The method of claim 11, wherein the at least one application is associated with at least one workflow.

13. The method of claim 8, wherein the virtual machine is a Java virtual machine.

14. The method of claim 8, wherein the markup language is View Layout Markup Language.

15. A system for controlling a Multi-Function Product (MFP) comprising:
at least one application stored in a memory, wherein the application is associated with at least one workflow; and
a virtual machine coupled to the memory, wherein the virtual machine is operable to:
process the at least one application; and
control the operation of the at least one workflow based at least in part on the processing of the at least one application.

16. The system of claim 15, further comprising a back end of a Graphical User Interface (GUI), wherein the back end is coupled to the virtual machine, and wherein the back end of the GUI is operable to suspend the control of the workflow by the virtual machine upon the detection of an error.

17. The system of claim 15, wherein the virtual machine is further operable to send a plurality of screen components defined by a markup language to a Graphical User Interface (GUI) for rendering by the GUI.

18. A Multi-Function Product (MFP), comprising:
an application stored in a memory, wherein the application is associated with at least one of a plurality of screen components defined by a markup language;
a back end of a Graphical User Interface (GUI), wherein the back end of the GUI is operable to receive at least one of the plurality of screen components; and
a virtual machine coupled to the GUI, wherein the virtual machine is operable to transmit the at least one of the plurality of screen components to the GUI based, at least in part, on the processing of the application stored in memory.

19. The MFP of claim 18, wherein the application is associated with at least one workflow.

20. The MFP of claim 18, wherein the memory is remote to the MFP.
